(19) United States
(12) Patent Application Publication
(10) Pub. No.: US 2013/0228616 A1
(43) Pub. Date: Sep. 5, 2013

(54) Dynamic Payment Card

(71) Applicants: Amit Bhosle, Bellevue, WA (US); Ammar Chinoy, Seattle, WA (US); Michael Donikian, Seattle, WA (US); Ashish Agrawal, Seattle, WA (US)

(72) Inventors: Amit Bhosle, Bellevue, WA (US); Ammar Chinoy, Seattle, WA (US); Michael Donikian, Seattle, WA (US); Ashish Agrawal, Seattle, WA (US)

(73) Assignee: AMAZON TECHNOLOGIES, INC., Reno, NV (US)

(21) Appl. No.: 13/411,150

(22) Filed: Mar. 2, 2012

(51) Int. Cl. G06K 19/073; G06K 19/06; G06F 17/00

(52) U.S. Cl. 235/375; 235/492; 235/493

(57) ABSTRACT

Disclosed are various embodiments for the creation of a payment card that is programmable by a user in order to access one or more accounts from multiple financial institutions and/or other institutions. The payment card includes an account selection application that facilitates selection of one of the transaction accounts associated with the payment card. A processor circuit then determines a code that corresponds with the respective one of the transaction accounts and facilitates the embodiment of the corresponding code to a dynamic magnetic strip located on the payment card.

### BACKGROUND

Many credit cards offer rewards for purchases. These can include perks for entertainment, travel, shopping and services. Gasoline station credit cards often offer lower gas prices for those who use their card for gas purchases. Many retailers offer percentage discounts off purchases or coupons to entice consumers to use a particular credit card. Additionally, credit cards provide a mechanism for making large purchases without carrying cash, for paying expenses over time, for online shopping, and for traveling.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of payment card interaction environment according to various embodiments of the present disclosure.

FIGS. 2A-2C are drawings of examples of the payment card of FIG. 1 according to various embodiments of the present disclosure.

FIG. 3 is a flowchart illustrating one example of functionality implemented as portions of account selection application executed in a payment card in the payment card interaction environment of FIG. 1 according to various embodiments of the present disclosure.

### DETAILED DESCRIPTION

The present disclosure relates to a payment card that is programmable by a user in order to access one or more accounts from multiple financial institutions and/or other institutions. Various embodiments of the present disclosure facilitate the transmission of information relating to one or more transaction accounts to a dynamic magnetic strip of a payment card. For example, the payment card may correspond to a credit card, a debit card, a gift card, and/or other card. In one embodiment, the payment card includes an account selection application that facilitates selection of one of the transaction accounts associated with the payment card. Once an account is selected, the account selection application identifies a code that corresponds with the selected one of the transaction accounts. After the account selection application has identified the code, the code is then embodied in a dynamic account code mechanism. The dynamic account code mechanism may be a dynamic magnetic strip of the payment card. Alternatively, the dynamic account code mechanism may be one of a plurality of radio frequency identification (“RFID”) tags that is enabled or configured for the selected one of the transaction accounts. In the following discussion, a general description of the system and its components is provided, followed by a discussion of the same.

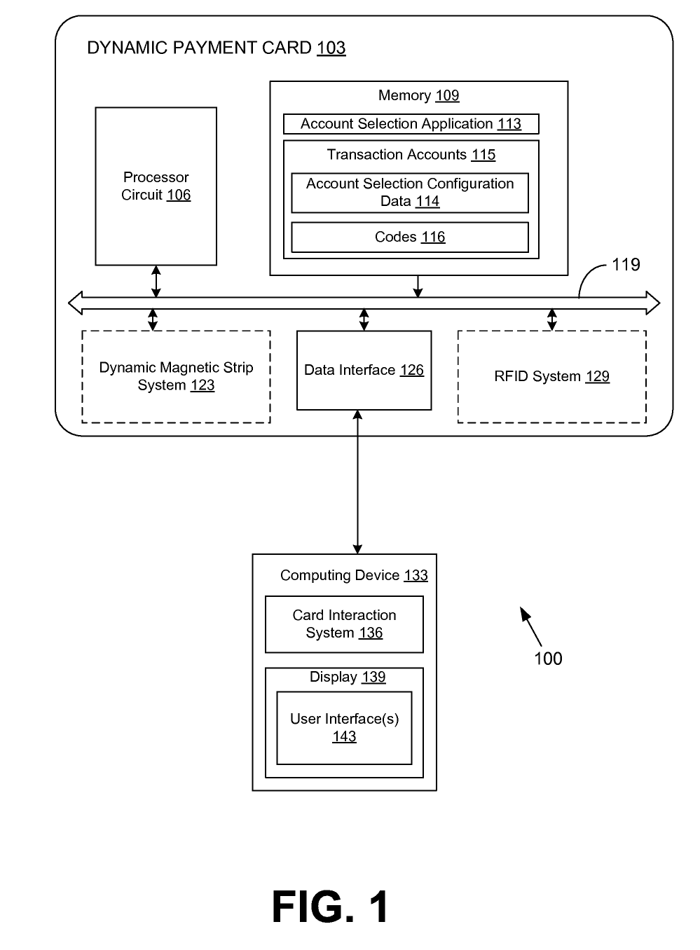

With reference to FIG. 1, shown is the payment card interaction environment 100 according to various embodiments. The payment card 103 includes a processor circuit 106, a memory 109, both of which are coupled to a local interface 119. The local interface 119 may comprise, for example, a data bus with an accompanying address/control bus or other bus structure as can be appreciated. Stored in the memory 109 are both data and several components that are executable by the processor circuit 106. In particular, stored in the memory 109 and executable by the processor circuit 106 is the account selection application 113, and potentially other applications. Also stored in the memory 109 may be account selection configuration data 114, transaction accounts 115, codes 116 and other data. In addition, an operating system may be stored in the memory 109 and executable by the processor circuit 106.

It is understood that there may be other applications that are stored in the memory 109 and are executable by the processor circuit 106 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 109 and are executable by the processor circuit 106. In this respect, the term “executable” means a program file that is in a form that can ultimately be run by the processor 106. Examples of executable programs may be, for example, a compiled program that can be translated into machine code in a format that can be loaded into a random access portion of the memory 109 and run by the processor 106, source code that may be expressed in proper format such as object code that is capable of being loaded into a random access portion of the memory 109 and executed by the processor circuit 106, or source code that may be interpreted by another executable program to generate instructions in a random access portion of the memory 109 to be executed by the processor circuit 106, etc. An executable program may be stored in any portion or component of the memory 109 including, for example, random access memory (RAM), read-only memory (ROM), memory card, or other memory components.

The memory 109 is defined herein as including both volatile and nonvolatile memory and data storage components. Volatile components are those that do not retain data values upon loss of power. Nonvolatile components are those that retain data upon a loss of power. Thus, the memory 109 may comprise, for example, random access memory (RAM), read-only memory (ROM), memory cards accessed via a memory card reader, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor circuit 106 may represent multiple processor circuits 106 and the memory 109 may represent multiple memories 109 that operate in parallel processing circuits, respectively. In such a case, the local interface 119 may facilitate communication between any two of the multiple processor circuits 106, between any processor circuit 106 and any of the memories 109, or between any two of the memories 109, etc. The local interface 119 may comprise additional systems designed to coordinate this communication. The processor circuit 106 may be of electrical or of some other available construction.

The memory 109 may include an account selection application 113, account selection configuration data 114, transaction accounts 115, and codes 116. The processor circuit 106 executes the account selection application 113 and directs operation of the dynamic magnetic strip system 123, the data interface 126, the RFID system 129, and/or any other system. The account selection application 113 enables the user of a single card to access many different transaction accounts 115 with the single card. Account selection configuration data 114 is data that may be configured by the data interface 126 that is accessed by the account selection application 113 in selecting the transaction account 115. Transaction accounts 115 identify the particular account which may be debited or credited when a purchase, a cash advance, and/or other transaction is made by a user of the payment card 103. For example, transaction accounts 115 may comprise a credit card account, a checking account, a gift card account, a stored value account, and/or other account.

Codes 116 stores a unique number that is associated with a corresponding one of the transaction accounts 115. For example, the code 116 may correspond to any existing credit card, debit card, gift card, and/or other card that a user may already own. Alternatively, codes 116 may correspond to a transaction account 115 that the user does not currently have.

The dynamic magnetic strip system 123 may be dynamically loaded with a code 116 associated with one of the transaction accounts 115. The data interface 126 facilitates the process of moving data between a computing device 133 and the payment card 103. The RFID system 129 may be configured to dynamically generate a code 116 associated with a corresponding one of the transaction accounts 115.

The computing device 133 may be representative of a plurality of computing devices 133. The computing device 133 may comprise, for example, a processor-based system such as a computer system. Such a computer system may be embodied in the form of a desktop computer, a laptop computer, a personal digital assistant, a cellular telephone, web pads, tablet computer systems, game consoles, or other devices with like capability. The computing device 133 may be configured to execute various applications such as a card interaction system 136, and/or other applications. Additionally, the computing device 133 may include a display 139. The display 139 may comprise, for example, one or more devices such as cathode ray tubes (CRTs), liquid crystal display (LCD) screens, gas plasma-based flat panel displays, LCD projectors, or other types of display devices, etc.

The card interaction system 136 may be executed in a client device, for example, to access and render network pages, such as web pages, or other network content. The computing device 133 may be configured to execute applications beyond card interaction system 136 such as, for example, email applications, instant message applications, and/or other applications. The card interaction system 133 includes graphical information that is employed, for example, to dynamically generate one or more user interfaces 143 that are transmitted to computing device 133 in order to enable a user that manipulates such computing device 133 to interact with the payment card 103 as will be described.

The card interaction system 136 is configured to receive input provided by the user and send this input via the data interface 126 to the payment card 103. The card application system 136 is also configured to obtain output data and render the same on the display 139. In one embodiment, the card interaction system 136 comprises a plug-in within a browser application. The computing device 133 may include a touch screen display device and may include one or more other input devices. Such input devices may comprise, for example, devices such as keyboards, mice, joysticks, accelerometers, light guns, game controllers, touch pads, touch sticks, push buttons, optical sensors, microphones, webcams, and/or any other devices that can provide user input.

Next, a general description of the payment card 103 and the operation of the various components of the payment card 103 are provided. To begin, a user employing a computing device 133 interacts with the payment card 103 via card interaction system 136. The card interaction system 136 allows a user manipulating a computing device 133 to send data to the payment card 103 via the data interface 126. The data interface 126 facilitates the process of transmitting information to the payment card 103. Such information may include, for example, transaction accounts 115, codes 116, account types, credit limits, reward points, available credit, cash advance limits, pin codes, and/or other information.

The processor circuit 106 executes the account selection application 113. The account selection application 113 may be implemented to facilitate the selection of one or more transaction accounts 115 which may be debited or credited when a purchase, a cash advance, and/or other transaction is made by a user of the payment card 103. For example, the payment card 103 may be used to access different transaction accounts 115 associated with different financial institutions. Alternatively, the payment card 103 may be used to access multiple transaction accounts 115 associated with the same financial institution. After identifying the appropriate transaction account 115 to be debited or credited, the account selection application 113 then facilitates the control of the operation of the dynamic magnetic strip system 123 to embody a code 116 that is associated with the respective one of the transaction accounts 115. A magnetic strip of the dynamic magnetic strip system 123 is rewritten to include the corresponding code 116 associated with the respective one of the transaction accounts 115.

Alternatively, after identifying the appropriate transaction account 115 to be debited or credited, the account selection application 113 then facilitates the control of the operation of the RFID system 129. The RFID system 129 may be composed of the tag, reader and antennae, the reader reads the tag information through the antennae, and the tag information is transmitted to the application system after decoding. The RFID system 129 may be configured to embody the code 116 associated with the selected one of the transaction accounts 115 for the transaction. Of note the demands for ensuring the security of collecting the tag data are becoming increasingly stronger. Therefore, the RFID system 129 may be configured to transmit data only after a user transmits a correct security credential associated with the payment card 103 such as, for example, passwords, pin codes, public key encryption, etc. Alternatively, the RFID system 129 can also be triggered by a different security credential to automatically disable the RFID system 129, for example as a user leaves a store.

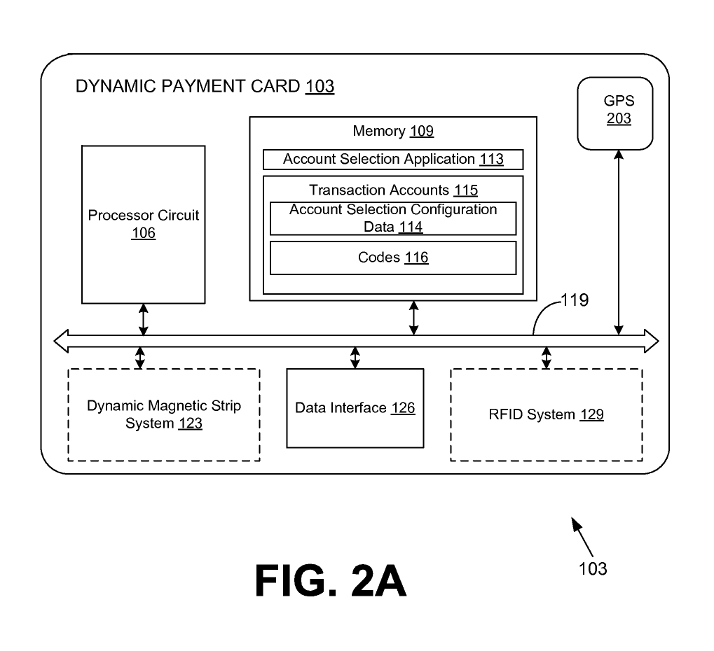

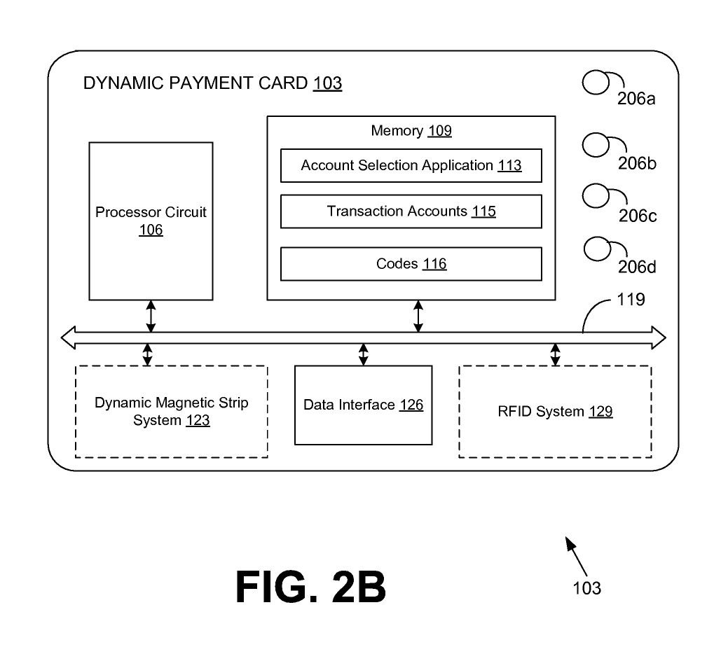

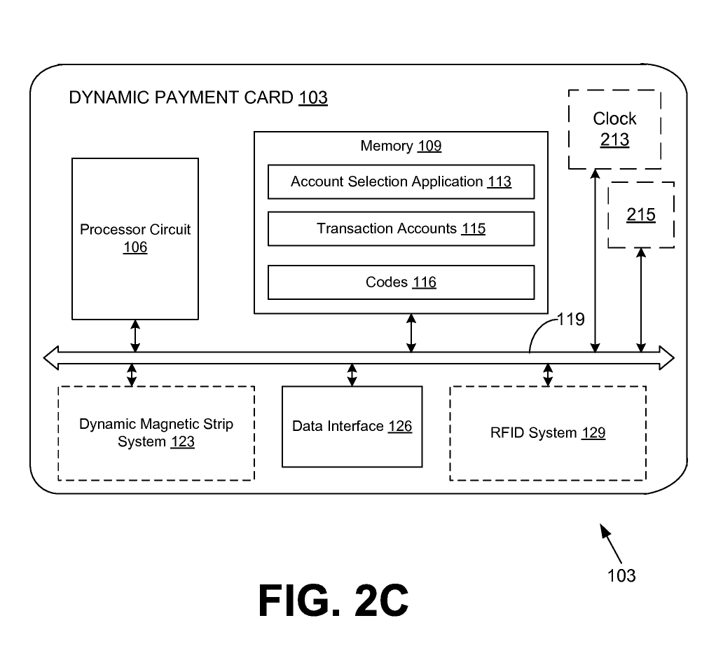

Referring next to FIG. 2A, shown is an example of the payment card 103 that includes a location system 203. In one embodiment the location system 203 is coupled to a local interface 119. The location system 203 may be configured to generate a location of the payment card 103 and provide the location of the payment card 103 to the account selection application 113. Such a location may be generated by a global positioning system (GPS) receiver or other location-finding device of the payment card 103. The account selection application 113 is implemented to facilitate selection of one of the transaction accounts 115 (FIG. 1). Once the appropriate transaction account 115 has been selected, the account selection application 113 facilitates the control of the dynamic magnetic strip system 123 or the RFID system 129 to embody a code 116 that is associated with the selected one of the transaction accounts 115. The information that embodied on the dynamic magnetic strip system 123 or the RFID system 129 may be readable by any existing POS system with a reader.

Turning now to FIG. 2B, shown is an example of a payment card 133 that includes one or more user input mechanisms 206a . . . 206d. The user input mechanisms 206a . . . 206d can be touch screen display devices, buttons, and/or any other mechanisms for providing user input. In one embodiment, the user input mechanisms 206a . . . 206d facilitate the selection of one or more transaction accounts 115 by allowing a user of the payment card 103 to manually select an appropriate transaction account 115 to be debited or credited. Additionally, the user input mechanisms 206a . . . 206d communicate with the processor circuit 106. The user input mechanisms 206a . . . 206d provide a user selected one of the transaction accounts 115 to the account selection application 113. In some embodiments, as indicated above, the information on the dynamic magnetic strip system 123 may be overwritten with new information that corresponds to the code 116 that is associated with the selected one of the transaction accounts 115. Alternatively, after a user of the payment card 103 has chosen one of the transaction accounts 115, the RFID system 129 may embody a code 116 that is associated with the user selected one of the transaction accounts 115.

Moving on to FIG. 2C, shown is another example of a payment card 103 that may include an internal clock 213 or an accelerometer 215. The internal clock 213 may be configured to provide a time to the account selection application 113. The account selection application 113 facilitates selection of one of the transaction accounts 115 based on the time provided by the internal clock 213. For example, account selection application 113 may select the appropriate transaction account 115 based on time of day, month of the year, day of week, etc. Similarly, the accelerometer 215, may allow for the payment card 103 to be rotated and may inform the account selection application 113 that the orientation of payment card 103 has changed or detect other movement of payment card 103. The account selection application 113 may select the appropriate transaction account 115 based on the orientation of the payment card 103 or the movement of the payment card 103 detected by the accelerometer 215. Once the appropriate transaction account 115 has be determined, the account selection application 113 facilitates the embodiment of a code 116 that is associated with the transaction account 115 to a magnetic strip of the dynamic magnetic strip system 123. Alternatively, the RFID system 129 may embody a code 116 that is associated with the selected one of the transaction accounts 115.

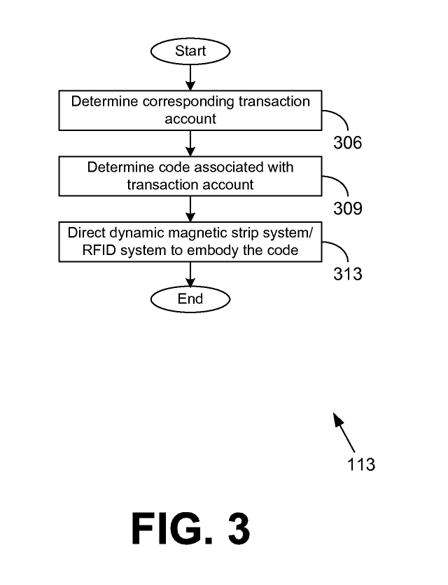

Referring next to FIG. 3, shown is a flowchart that provides one example of the operation of a portion of the account selection application 149 that is implemented to facilitate the transmission of information relating to one or more transaction accounts 119 (FIG. 1) to a dynamic magnetic strip 153 (FIG. 1) of a payment card 143 (FIG. 1) according to various embodiments. It is understood that the flowchart of FIG. 3 provides merely an example of the many different types of functional arrangements that may be employed to implement the operation of the portion of the account selection application 149 as described herein. As an alternative, the flowchart of FIG. 3 may be viewed as depicting an example of steps of a method implemented in the payment card interaction environment 100 (FIG. 1) according to one or more embodiments.

Beginning with box 306, when a user desires to use a payment card 103 for purchases and other transactions, the account selection application 113 determines the appropriate transaction account 115. In one embodiment, the transaction account 115 may be determined based on a location of the payment card 103. In another embodiment, a user may select the transaction account 115 through the use of an input mechanism 203a . . . 203d (FIG. 2B) such as, for example, touch screen display devices, buttons, and/or any other mechanisms for providing user input.

Additional mechanisms may be provided to generate input commands in response to an action taken relative to the physical orientation of the payment card 103. In one embodiment, the payment card 103 includes an accelerometer 215 or other device that can detect orientation, acceleration, and deceleration of the payment card 103. For example, the payment card 103 may be held in a predefined orientation. Once a user rotates the payment card 103, an accelerometer 215 or other type of device detects the orientation of payment card 103 and sends the orientation to the account selection application 113. The account selection application 113 may select the appropriate transaction account 115 based on the orientation of the payment card 103. In another embodiment, a user may tap the payment card 103 on one of the respective edges. The accelerometer 215 included in the payment card 103 detects the acceleration/deceleration of the payment card 103. Next, the accelerometer 215 sends the acceleration/deceleration information to the account selection application 113. The account selection application 113 selects the appropriate transaction account 115 based on the acceleration/deceleration information provided by the accelerometer 215 or other device.

In another embodiment, the account selection application 113 may determine the appropriate transaction account 115 based at least in part on input provided by an internal clock 213 (FIG. 2C). The internal clock 213 may provide information to the account selection application 113 such as, time of day, day of the week, month of year, etc. The account selection application 113 may select the appropriate transaction account 115 based on time of day, month of the year, day of week, etc.

After determining the appropriate transaction account 115 to be used, the account selection application 113 then proceeds to box 309. In box 309, the account selection application 113 determines a code 116 associated with the selected transaction account 115. In box 313, the account selection application 113 directs the operation of the dynamic magnetic strip system 123 or the RFID system 129 to embody the code 116 associated with the selected one of the transaction accounts 115 in a form that is readable by existing POS systems.

Although the account selection application 113, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the account selection application 113. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor circuit 106 in a payment card 103, a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including account selection application 113 that comprises software or code can be embodied in any non-transitory computer-readable medium for use by or in connection with an instruction execution system such as, for example, a processor circuit 106 in a payment card 103, computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, the program comprising:
code that facilitates a selection of one of a plurality of transaction accounts based on an input from an input mechanism located on a payment card, the input being selected from a group consisting of: a location system, a user input, and an internal clock, wherein the input mechanism is in communication with a processor circuit positioned on the payment card, wherein the input is provided by a mechanism selected from a group consisting of: a touch screen display device, a plurality of buttons, and a keyboard; and
code that directs a dynamic account code mechanism located on the payment card to embody a code associated with the selected one of the transaction accounts.

2. The non-transitory computer-readable medium of claim 1, wherein the location system is configured to generate a location of the payment card and provide the location to an account selection application.

3. The non-transitory computer-readable medium of claim 2, wherein the code that facilitates the selection of the one of the transaction accounts further comprises code that selects the one of the transaction accounts based at least in part on the location of the payment card.

4. The non-transitory computer-readable medium of claim 1, wherein the dynamic account code mechanism is a dynamic magnetic strip system.

5. The non-transitory computer-readable medium of claim 1, wherein the dynamic account code mechanism is an RFID system.

6. The non-transitory computer-readable medium of claim 1, wherein the code that facilitates the selection of the one of the plurality of transaction accounts is stored on a server.

7. The non-transitory computer-readable medium of claim 6, wherein the code that directs the dynamic account code mechanism is stored on the server.

8. The non-transitory computer-readable medium of claim 7, wherein the payment card is configured to communicate with the server.

9. A payment card, comprising:
a dynamic magnetic strip;
a processor circuit; and
an account selection application executed by the processor circuit, the account selection application comprising:
logic that facilitates a selection of one of a plurality of transaction accounts; and
logic that directs the dynamic magnetic strip to embody a code associated with the one of the transaction accounts that has been selected.

10. The payment card of claim 9, further comprising a global positioning system in communication with the processor circuit, the global positioning system being configured to generate a location of the payment card and provide the location of the payment card to the account selection application.

11. The payment card of claim 10, wherein the logic that facilitates the selection of one of the transaction accounts further comprises logic that selects the one of the transaction accounts based at least in part on the location of the payment card.

12. The payment card of claim 9, further comprising a user input mechanism in communication with the processor circuit, the user input mechanism being configured to provide the selected one of the transaction accounts to the account selection application.

13. The payment card of claim 12, wherein the logic that facilitates the selection of one of the transaction accounts further comprises logic that selects the one of the transaction accounts based at least in part on the user input.

14. The payment card of claim 12, wherein the user input mechanism further comprises at least one touch screen display device.

15. The payment card of claim 12, wherein the user input mechanism further comprises at least one button.

16. The payment of claim 12, wherein the user input mechanism further comprises an accelerometer.

17. The payment card of claim 9, further comprising an internal clock in communication with the processor circuit, the internal clock being configured to provide a time to the account selection application.

18. The payment card of claim 17, the logic that facilitates the selection of one of the transaction accounts further comprises logic that selects the one of the transaction accounts based at least in part on the time provided by the internal clock.

19. A method, comprising the steps of:
facilitating, in a computing device, a selection of one of a plurality of transaction accounts based at least in part on a user input mechanism; and
directing, in the computing device, a radio frequency identification (“RFID”) system positioned on a payment card to embody a code associated with the selected one of the transaction accounts.

20. The method of claim 19, wherein the user input mechanism communicates with a processor circuit.

21. The method of claim 20, wherein the user input mechanism is configured to provide the selected one of the transaction accounts to an account selection application.

22. The method of claim 21, wherein the user input mechanism further comprises at least one touch screen display device.

23. The method of claim 21, wherein the user input mechanism further comprises at least one button.

24. The method of claim 20, wherein the user input mechanism further comprises an accelerometer.

25. The method of claim 19, wherein the RFID is configured to be enabled by a user.
